(19) United States
(12) Patent Application Publication
(10) Pub. No.: US 2021/0379542 A1
(43) Pub. Date: Dec. 9, 2021

(54) BUBBLE GENERATOR

(71) Applicant: Murata Manufacturing Co., Ltd., Nagaokakyo-shi (JP)

(72) Inventors: Katsumi FUJIMOTO, Nagaokakyo-shi (JP); Yoshihiro KOGI, Nagaokakyo-shi (JP)

(21) Appl. No.: 17/408,633

(22) Filed: Aug. 23, 2021

Related U.S. Application Data
(63) Continuation of application No. PCT/JP2020/009069, filed on Mar. 4, 2020.

(30) Foreign Application Priority Data
Mar. 19, 2019 (JP) 2019-050880

(51) Int. Cl. B01F 3/04

(52) U.S. Cl. CPC B01F 3/04978; B01F 3/04829; B01F 2215/0052; B01F 2003/04858; B01F 3/04106

(57) ABSTRACT

A bubble generator includes a diaphragm, a tube, and a piezoelectric vibrator. The tube includes a first end portion and a second end portion opposite to the first end portion, and the tube is connected to the diaphragm at the first end portion so as to support the diaphragm. The piezoelectric vibrator is fixed to a ring-shaped collar extending radially outward from the tube at a position in a vicinity of the second end portion of the tube, and the piezoelectric vibrator vibrates the tube. The first end portion of the tube is joined to the water tank.

### CROSS REFERENCE TO RELATED APPLICATIONS

This application claims the benefit of priority to Japanese Patent Application No. 2019-050880 filed on Mar. 19, 2019 and is a Continuation Application of PCT Application No. PCT/JP2020/009069 filed on Mar. 4, 2020. The entire contents of each application are hereby incorporated herein by reference.

### BACKGROUND OF THE INVENTION

### 1. Field of the Invention

The present disclosure relates to a bubble generator.

### 2. Description of the Related Art

In recent years, micro bubbles have been used in various fields, for example, in water purification, wastewater treatment, or fish raising. A bubble generator to generate micro bubbles has been developed (Japanese Patent No. 6108526).

The bubble generator described in Japanese Patent No. 6108526 utilizes a piezoelectric device to generate micro bubbles. This bubble generator includes a diaphragm that flexurally vibrates. Bubbles are generated at micro apertures formed through the diaphragm, and the bubbles are torn into micro pieces by vertical vibrations of a central portion of the flexurally vibrating diaphragm. Accordingly, the diaphragm having micro apertures is continuously exposed to a liquid, such as water. In addition, it is necessary to form a space under the diaphragm for introducing the gas for bubble generation.

In the bubble generator described in Japanese Patent No. 6108526, the diaphragm that separates the liquid and air from each other is supported by concentrically disposed rubber elastic bodies made of, for example, silicone rubber. In the case in which the diaphragm is supported by the rubber elastic bodies, when the diaphragm is vibrated to generate micro bubbles, the rubber elastic bodies partially absorb the vibration of the diaphragm, which may lead to a problem that the bubble generation efficiency of the bubble generator is deteriorated.

On the other hand, in the case in which the diaphragm is supported by a rigid and inelastic partition while the partition separates the liquid and the air from each other, when the diaphragm is vibrated to generate bubbles, vibrations of the diaphragm are transmitted through the partition to the water tank.

### SUMMARY OF THE INVENTION

Preferred embodiments of the present invention provide bubble generators that do not deteriorate the generation efficiency of micro bubbles while the diaphragm separates a liquid and air from each other.

A bubble generator according to a preferred embodiment of the present disclosure generates micro bubbles in a liquid by vibration. The bubble generator includes a diaphragm through which multiple cavities are provided, and the diaphragm includes a first surface to be in contact with the liquid in a liquid tank and a second surface to be in contact with a gas. The bubble generator also includes a tube that includes a first end portion and a second end portion positioned opposite to the first end portion and is connected to the diaphragm at the first end portion so as to support the diaphragm. The bubble generator further includes a piezoelectric vibrator fixed to a ring-shaped collar extending radially outward from the tube at a position in a vicinity of the second end portion, and the piezoelectric vibrator vibrates the tube. The first end portion of the tube is joined to the liquid tank.

According to preferred embodiments of the present disclosure, the bubble generators each have a structure in which the diaphragm is connected to the first end portion of the tube and the piezoelectric vibrator is on the ring-shaped collar at the second end portion. With this configuration, the bubble generators are able to improve the generation efficiency of micro bubbles while the diaphragm separates the liquid and air from each other.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic view illustrating a water purifier in which a bubble generator according to a preferred embodiment of the present invention is used.

FIG. 2 is a perspective view illustrating a bubble generator according to a preferred embodiment of the present invention.

FIG. 3 is a cross-sectional view illustrating a half section of a bubble generator according to a preferred embodiment of the present invention.

FIG. 4 is a view for explaining vibration of a diaphragm included in a bubble generator according to a preferred embodiment of the present invention.

FIG. 5 is a view illustrating resonance characteristics when a ring-shaped piezoelectric device of a bubble generator according to a preferred embodiment of the present invention is actuated.

FIG. 6 is a plan view illustrating a diaphragm according to a preferred embodiment of the present invention.

FIG. 7 is a cross-sectional view illustrating a cavity extending through a diaphragm according to a preferred embodiment of the present invention.

### DETAILED DESCRIPTION OF THE PREFERRED EMBODIMENTS

### Preferred Embodiments

Bubble generators according to a preferred embodiments will be described in detail with reference to the drawings. Note that the same or equivalent elements will be denoted by the same reference signs and the description will not be repeated.

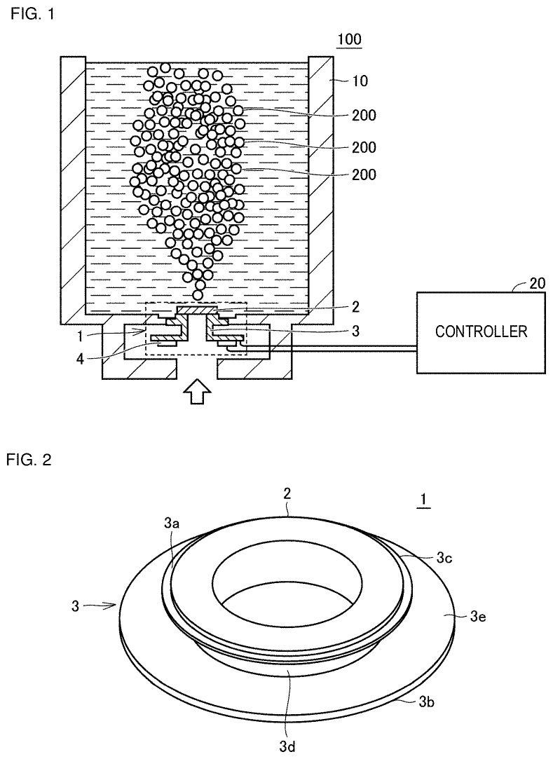

FIG. 1 is a schematic view illustrating a water purifier 100 in which a bubble generator 1 according to the present preferred embodiment is used. For example, the bubble generator 1 of FIG. 1 is used in the water purifier 100 to generate micro bubbles 200 in the water in a water tank (liquid tank) 10. The bubble generator 1 is installed at the bottom of the water tank 10. The application of the bubble generator 1 is not limited to the water purifier 100. The bubble generator 1 may be applied to various apparatuses, such as wastewater treatment apparatuses or fish-raising water tanks, for example.

The bubble generator 1 includes a diaphragm 2, a tubular member 3, and a piezoelectric device 4. The bubble generator 1 is configured such that the diaphragm 2 is disposed at a hole in a portion of the bottom of the water tank 10 and the piezoelectric device 4 vibrates the diaphragm 2 via the tubular member 3. Micro bubbles 200 are generated at multiple micro apertures (cavities) extending through the diaphragm 2.

The diaphragm 2 is defined by a glass plate. In the case of the diaphragm 2 being defined by the glass plate, the glass plate may be configured to transmit ultraviolet and deep ultraviolet light having a wavelength of, for example, about 200 nm to about 380 nm. The diaphragm 2 is defined by the glass plate that can transmit ultraviolet and deep ultraviolet light, and a light source may be disposed so as to emit the ultraviolet light to the water in the water tank 10 from a side region of the diaphragm 2 so that the water can be sterilized due to both ozone generation and ultraviolet irradiation. For example, the glass plate is made of silica glass or of synthetic silica glass of which the composition is controlled so as to improve transmission of deep ultraviolet rays. The diaphragm 2 may be defined by a metal plate or a material other than glass (for example, a metal, a resin, or others).

The diaphragm 2 includes multiple micro apertures extending therethrough. One surface of the diaphragm 2 is in contact with the water (a liquid) in the water tank 10, and the other surface is in contact with air (a gas). In other words, in the bubble generator 1, the water and the air are partitioned from each other with the diaphragm 2. When back pressure is applied to the other surface of the diaphragm 2 (in a direction indicated by the arrow in FIG. 1) and the diaphragm 2 is vibrated, micro bubbles 200 are generated in the water in the water tank 10 by the air supplied through the micro apertures.

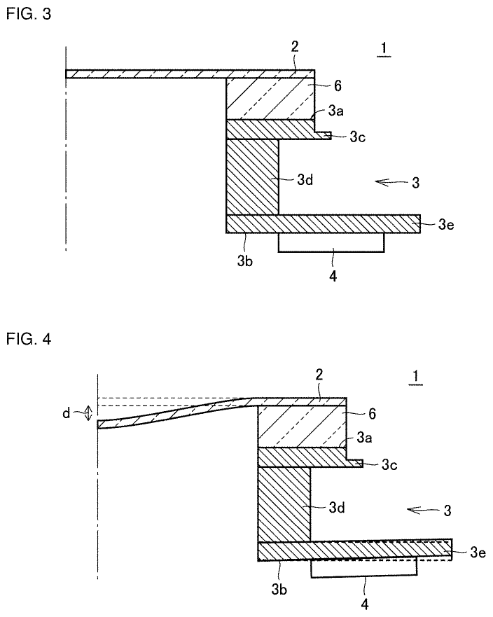

In the bubble generator 1, the piezoelectric device 4 causes the diaphragm 2 to vibrate using the tubular member 3 interposed therebetween. FIG. 2 is a perspective view illustrating the bubble generator 1 according to the present preferred embodiment. FIG. 3 is a cross-sectional view illustrating a half section of the bubble generator according to the present preferred embodiment. Note that in FIG. 3, the dash-dot line passes through the central axis of the tubular member 3.

The tubular member 3 is connected to the diaphragm 2. Note that in FIG. 2, the through hole of the tubular member 3 can be seen through the diaphragm 2 that is defined by the glass plate. In the case of the diaphragm 2 being made of an opaque material, such as a metal, however, the through hole of the tubular member 3 cannot be seen through the diaphragm 2 in FIG. 2. The tubular member 3 has a tube shape. The tubular member 3 includes a first end portion 3a and a second end portion 3b that is opposite to the first end portion 3a. The second end portion 3b is positioned opposite to the first end portion 3a in the axial direction of the tubular member.

The first end portion 3a is connected to the diaphragm 2. In other words, the first end portion 3a of the tubular member 3 is fixed to the surface of the diaphragm 2 on the side closer to the tubular member 3 such that the diaphragm 2 closes the opening at the first end portion 3a of the tubular member 3.

In the present preferred embodiment, the tubular member 3 is made of stainless steel, for example. The tubular member 3 may be made of other material. It is preferable that the tubular member 3 is made of a metal having rigidity, such as stainless steel, for example.

The tubular member 3 includes a flange 3c extending radially outward from the side surface of the tubular member 3. For example, as illustrated in FIG. 1, the flange 3c is connected to the hole of the water tank 10 provided at a portion of the bottom thereof. The first end portion 3a of the tubular member 3 is thus joined to the water tank 10. When the piezoelectric device 4 causes the diaphragm 2 to vibrate using the tubular member 3 interposed therebetween, the flange 3c does not vibrate much. Accordingly, the piezoelectric device 4 can vibrate only the diaphragm 2 without transmitting vibrations from the piezoelectric device 4 to the water tank 10.

A ring-shaped collar 3e is provided at the second end portion 3b of the tubular member 3 so as to extend radially outward. The ring-shaped collar 3e has a doughnut shape as viewed in plan. A portion between the flange 3c and the ring-shaped collar 3e is a tubular body 3d. The outside diameter of the ring-shaped collar 3e is larger than the outside diameter of the tubular body 3d. As illustrated in FIG. 3, the outside diameter of the tubular body 3d is smaller than the outside diameter of the diaphragm 2 in the present preferred embodiment, although this does not limit the scope of the present invention.

The ring-shaped collar 3e and the tubular body 3d may be made of the same material as a single component. In the present preferred embodiment, however, the ring-shaped collar 3e and the tubular body 3d are separate members, and the ring-shaped collar 3e is joined to the end surface of the tubular body 3d that is opposite to the diaphragm 2. Accordingly, the ring-shaped collar 3e may be a different member from the tubular body 3d.

A ring-shaped piezoelectric device 4 is fixed to the surface of the ring-shaped collar 3e that is opposite to the surface closer to the diaphragm 2. The ring-shaped piezoelectric device 4 includes a ring-shaped piezoelectric member and electrodes disposed on respective opposite surfaces of the ring-shaped piezoelectric member. The ring-shaped piezoelectric member is polarized in the thickness direction, in other words, in the direction in which the first end portion 3a and the second end portion 3b of the tubular member 3 oppose each other. The ring-shaped piezoelectric member is made of a piezoelectric substance, such as piezoelectric ceramics, for example.

The ring-shaped collar 3e and the ring-shaped piezoelectric device 4 fixed thereto define a vibrator that causes the diaphragm 2 to vibrate flexurally. For example, the ring-shaped piezoelectric device 4 has an inside diameter of about 12 mm, an outside diameter of about 18 mm, and a thickness of about 1 mm. The piezoelectric device 4 is driven by rectangular waves with a voltage of about 50 Vpp to about 70 Vpp and a duty ratio of about 50%, for example.

In the bubble generator 1, the flexural vibration of the piezoelectric device 4 is transmitted to the diaphragm 2 through the tubular member 3, and the vibration of the diaphragm 2 generates the micro bubbles 200. A controller 20 supplies a signal to the electrodes of the piezoelectric device 4, and the signal drives the piezoelectric device 4.

Note that the piezoelectric device 4 is not limited to the above-described structure including the ring-shaped piezoelectric member and the electrodes disposed on respective opposite surfaces thereof. The piezoelectric device 4 may, for example, include multiple piezoelectric members provided in a ring shape and the electrodes provided on both surfaces of each piezoelectric member.

As illustrated in FIG. 3, the diaphragm 2 is connected to the first end portion 3a of the tubular member 3 with a support glass 6 interposed therebetween. For example, when the thickness of the diaphragm 2 is about 0.2 mm, the thickness of the support glass 6 may be about 1.1 mm. The diaphragm 2 may be directly connected to the first end portion 3a of the tubular member 3 without having the support glass 6 therebetween.

The bubble generator 1 is configured such that the diaphragm 2 in contact with the liquid is defined by the glass plate and the piezoelectric device 4 vibrates the diaphragm 2 via the tubular member 3. This enables a space to introduce the gas to be completely isolated from the liquid. Complete isolation between the liquid and the space to introduce the gas can prevent electric wiring or the like of the piezoelectric device 4 from coming into contact with the liquid. In addition, in the bubble generator 1, a light source can be provided in the space to introduce the gas, which also prevents electric wiring or the like of the light source from coming into contact with the liquid.

Next, vibration of the diaphragm 2 in the bubble generator 1 will be described in detail. FIG. 4 is a view for explaining the vibration of the diaphragm 2 in the bubble generator according to the present preferred embodiment. FIG. 4 illustrates a half section of the bubble generator 1 and simulated displacement of the diaphragm 2 when the diaphragm 2 vibrates. Note that in FIG. 4, the dash-dot line passes through the central axis of the tubular member 3.

In the bubble generator 1 of FIG. 4, the tubular member 3, the ring-shaped collar 3e, and the ring-shaped piezoelectric device 4 are connected to the diaphragm 2. Applying an alternating electric field between the electrodes of the ring-shaped piezoelectric device 4 flexurally vibrates the layered body of the ring-shaped piezoelectric device 4 and the ring-shaped collar 3e. The displacement of the flexural vibration is transmitted to the diaphragm 2 through the tubular body 3d of the tubular member 3. This flexurally vibrates the diaphragm 2 with a central portion thereof being displaced largely. As illustrated in FIG. 4, in the bubble generator 1, the central portion of the diaphragm 2 is displaced by a displacement d due to the flexural vibration.

When the ring-shaped piezoelectric device 4 vibrates the ring-shaped collar 3e and thus vibrates the diaphragm 2 flexurally as illustrated in FIG. 4, the bubble generator 1 can vibrate in a first mode in which the central portion of the diaphragm 2 is displaced in opposite phase relative to the displacement of the peripheral portion of the ring-shaped collar 3e and also can vibrate in a second mode in which both portions are displaced in phase.

When the diaphragm 2 is vibrated in the first mode, a node appears in the vicinity of the flange 3c in the bubble generator 1, and vibration does not substantially occur in the vicinity of the flange 3c.

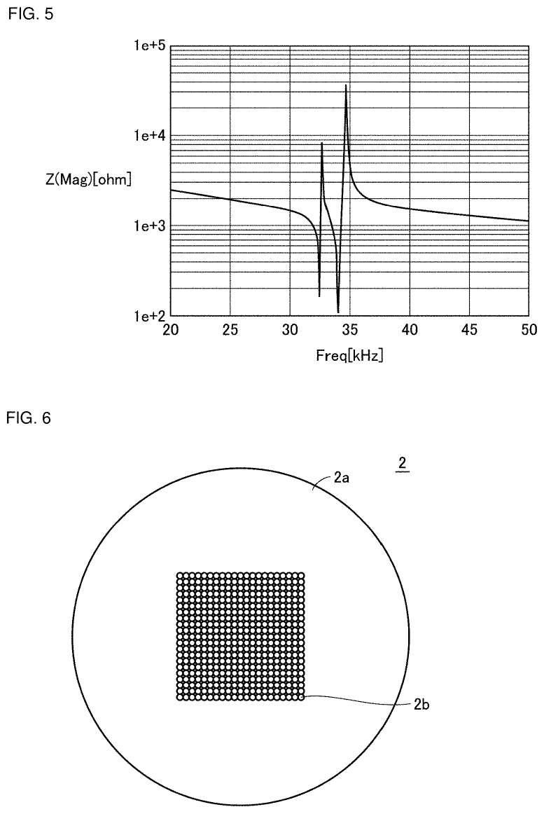

FIG. 5 is a view illustrating resonance characteristics when the ring-shaped piezoelectric device 4 of the bubble generator according to the present preferred embodiment is actuated. As illustrated in FIG. 5, the response in the first mode appears on a low-frequency side, whereas the response in the second mode appears on a high-frequency side.

Here, the resonant frequency of the first mode appears in the vicinity of 32.5 kHz, and the resonant frequency of the second mode appears in the vicinity of 34.0 kHz.

Note that changing the outside diameter and the thickness of the ring-shaped collar 3e can largely shift the response frequencies in the first mode and in the second mode of the flexural vibration.

Multiple micro apertures extend through the diaphragm 2. FIG. 6 is a plan view illustrating the diaphragm according to the present preferred embodiment. The diaphragm 2 of FIG. 6 is defined by a glass plate 2a having a diameter of about 14 mm in which multiple micro apertures 2b are provided in an approximately 5 mm by 5 mm region at a central portion thereof. For example, when the diameter of each micro aperture 2b is set to be about 10 μm and the spacing between adjacent micro apertures 2b is set to be about 0.25 mm, four hundred and forty one micro apertures 2b can be provided in the approximately 5 mm by 5 mm region of the diaphragm 2. Note that in FIG. 6, the diameter and the spacing of the micro apertures 2b are illustrated differently from actual apertures to provide a picture of many micro apertures 2b being provided in the glass plate 2a.

The diameter of each micro aperture 2b in the diaphragm 2 is, for example, about 1 μm to about 20 μm when measured at the opening of the aperture that comes into contact with the liquid. Introducing air through the micro apertures 2b generates micro bubbles 200 in the water in the water tank 10. An approximate diameter of each micro bubble 200 is, for example, about 10 times larger than the aperture diameter. The micro apertures 2b are arrayed at, for example, a spacing of about 10 times or more larger than the aperture diameter, which prevents micro bubbles 200 generated at one micro aperture 2b from merging other micro bubbles 200 generated at adjacent micro apertures 2b. This improves performance of generating discrete micro bubbles 200.

For example, the micro apertures 2b can be formed through the glass plate 2a using a method in which laser irradiation and liquid-phase etching are combined. More specifically, the glass plate 2a is irradiated with laser beams, and the laser energy denatures the composition of the glass plate 2a. The denatured portion is etched with a liquid fluoride-based etching material to form the micro aperture 2b.

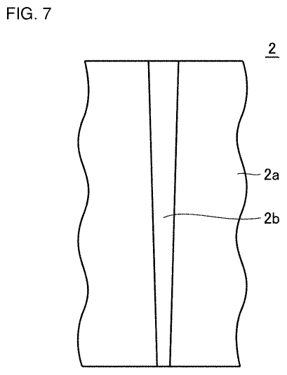

FIG. 7 is a cross-sectional view illustrating a micro aperture (cavity) 2b extending through the diaphragm according to the present preferred embodiment. As illustrated in FIG. 7, the micro aperture 2b extending through the glass plate 2a has a tapered shape in which the aperture diameter at the upper surface in the figure is larger than that at the lower surface. The diaphragm 2 is disposed such that the surface with the smaller diameter apertures is in contact with the water in the water tank 10 and the surface with the larger diameter apertures is in contact with the gas, which can further reduce the diameter of each micro bubble 200 generated at the micro aperture 2b. However, the diaphragm 2 may be disposed oppositely, in other words, the surface with the larger diameter apertures may be in contact with the water in the water tank 10 and the surface with the smaller diameter apertures may be in contact with the gas.

Providing the diaphragm 2 using the glass plate 2a is advantageous compared with a diaphragm defined by a metal plate in that the glass plate 2a can prevent liquid contamination from occurring due to metal ions being leached into the liquid. Moreover, in the case of micro apertures being formed in the metal plate, it is necessary to perform plating to prevent corrosion. It is also necessary to perform plating using a precious metal to prevent leaching of metal ions into the liquid. Precious metal plating on the metal plate having micro apertures increases the cost of the diaphragm.

As described above, the bubble generator 1 according to the present preferred embodiment generates micro bubbles 200 in the liquid by vibration. The bubble generator 1 includes the diaphragm 2, the tubular member 3, and the piezoelectric device 4. The diaphragm 2 includes a plurality of the micro apertures 2b extending therethrough, and the diaphragm 2 includes one surface to be in contact with the water (liquid) in the water tank 10 and the other surface to be in contact with the gas. The tubular member 3 includes the first end portion 3a and the second end portion 3b positioned opposite to the first end portion 3a, and the tubular member 3 is connected to the diaphragm 2 at the first end portion 3a so as to support the diaphragm 2. The piezoelectric device 4 is fixed to the ring-shaped collar 3e that extends radially outward from the tubular member 3 at a position near the second end portion 3b of the tubular member 3, and the piezoelectric device 4 vibrates the tubular member 3. The first end portion 3a of the tubular member 3 is joined to the water tank 10.

Accordingly, the bubble generator 1 has a structure in which the diaphragm 2 is connected to the first end portion 3a of the tubular member 3 and the piezoelectric device 4 is disposed on the ring-shaped collar 3e at the second end portion 3b. This enables the bubble generator 1 to improve the generation efficiency of micro bubbles while the diaphragm 2 separates the liquid and the air from each other. Moreover, the bubble generator 1 enables complete separation between the liquid and the space to introduce the gas, which can prevent electric wiring or the like of the piezoelectric device 4 from coming into contact with the liquid.

In addition, the ring-shaped collar 3e includes the first surface positioned closer to the diaphragm 2 and the second surface positioned opposite to the first surface, and the piezoelectric device 4 is fixed to the second surface. Accordingly, the bubble generator 1 can prevent the piezoelectric device 4 from coming into contact with the liquid.

In addition, the tubular member 3 may include the flange 3c at the first end portion, and the tubular member 3 may be joined to the water tank 10 with the flange 3c interposed therebetween. Accordingly, the bubble generator 1 can vibrate only the diaphragm 2 without transmitting vibrations from the piezoelectric device 4 to the water tank 10.

Moreover, the flange 3c, the tubular member 3, and the ring-shaped collar 3e may be integrally made of the same material. This can increase the strength of the flange 3c, the tubular member 3, and the ring-shaped collar 3e.

The diaphragm 2 may be defined by the glass plate. Accordingly, the bubble generator 1 can prevent liquid contamination due to metal ions being leached into the water (liquid) in the water tank 10.

Moreover, the glass plate may be connected to the tubular member 3 at the first end portion 3a with the support glass member 6 interposed therebetween.

Each one of the micro apertures 2b of the diaphragm 2 may have a diameter of, for example, about 1 μm to about 20 μm measured at the surface to be in contact with the liquid, and the micro apertures 2b may be provided with a spacing between adjacent micro apertures 2b being, for example, about 10 times larger than the diameter. With this configuration, the bubble generator 1 can prevent micro bubbles 200 generated at one micro aperture 2b from merging other micro bubbles 200 generated at adjacent micro apertures 2b, which enables discrete micro bubbles 200 to be generated.

Moreover, each one of the micro aperture 2b has the tapered shape in which the diameter of the aperture 2b at the one surface to be in contact with the water (liquid) in the water tank 10 is smaller than the diameter of the aperture 2b at the other surface to be in contact with the gas. This enables the bubble generator 1 to further reduce the diameter of each micro bubble 200 generated at the micro aperture 2b.

The preferred embodiments disclosed herein is construed, in all respects, not as limiting but as an example. The scope of the present invention is set forth not in the above descriptions but in the claims in which all of the modifications and alterations within the scope of the claims as well as the equivalents thereof are included.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A bubble generator that generates micro bubbles in a liquid by vibration, the bubble generator comprising:
a diaphragm including cavities, a first surface to be in contact with the liquid in a liquid tank, and a second surface to be in contact with a gas;
a tube including a first end portion and a second end portion opposite to the first end portion and connected to the diaphragm at the first end portion so as to support the diaphragm; and
a piezoelectric vibrator fixed to a ring-shaped collar extending radially outward from the tube at a position in a vicinity of the second end portion of the tube to vibrate the tube; wherein
the first end portion of the tube is joined to the liquid tank.

2. The bubble generator according to claim 1, wherein
the ring-shaped collar includes a first surface closer to the diaphragm and a second surface positioned opposite to the first surface farther from the diaphragm; and
the piezoelectric vibrator is fixed to the second surface.

3. The bubble generator according to claim 1, wherein
the tube includes a flange at the first end portion; and
the tube is joined to the liquid tank with the flange interposed therebetween.

4. The bubble generator according to claim 3, wherein the flange, the tube, and the ring-shaped collar are integrally made of the same material.

5. The bubble generator according to claim 1, wherein the diaphragm is defined by a glass plate.

6. The bubble generator according to claim 5, wherein the glass plate is connected to the tube at the first end portion with a support glass interposed therebetween.

7. The bubble generator according to claim 1, wherein
each of the cavities of the diaphragm has a diameter of about 1 μm to about 20 μm; and
the cavities are provided with a spacing between adjacent cavities being about 10 times greater than the diameter.

8. The bubble generator according to claim 1, wherein each of the cavities has a tapered shape in which a diameter of the respective cavity at the first surface to be in contact with the liquid in the liquid tank is smaller than a diameter of the cavity at the second surface to be in contact with the gas.

9. The bubble generator according to claim 5, wherein the glass plate is structured to transmit ultraviolet and deep ultraviolet light having a wavelength of about 200 nm to about 380 nm.

10. The bubble generator according to claim 5, wherein the glass plate is made of silica glass or synthetic silica glass.

11. The bubble generator according to claim 1, wherein the tube is made of stainless steel.

12. The bubble generator according to claim 1, wherein the piezoelectric vibrator has a ring shape.

13. The bubble generator according to claim 6, wherein the diaphragm has a thickness of about 0.2 mm, and the support glass has a thickness of about 1.1 mm.

14. The bubble generator according to claim 5, wherein the glass plate has a diameter of about 14 mm, and the cavities are provided in an approximate 5 mm by 5 mm region at a central portion of the glass plate.
